(19) United States
(12) Patent Application Publication
(10) Pub. No.: US 2004/0148740 A1
(43) Pub. Date: Aug. 5, 2004

(54) Holder for pens and the like

(76) Inventor: James Serafino Arnone, Kenmore, NY (US)

Correspondence Address: JAMES S. ARNONE, PO BOX 1771, BUFFALO, NY, 14240-1771, US

(21) Appl. No.: 10/356,821

(22) Filed: Feb. 3, 2003

(51) Int. Cl. B43K 25/00

(52) U.S. Cl. 24/11 FE

(57) ABSTRACT

“Holder for pens and the like,” a device that attaches to clothing or fabric material, mainly a shirt, coat or automotive seatbelt strap. The device utilizes a free turning or pivoting disk approximately ¾ inch in diameter with hook, loop or magnetic material attached to the surface of the disk. A writing instrument or other lightweight item, with hook, loop or magnetic material applied to it, can be easily attached to the disk with the use of one hand and will automatically hang vertically.

### BACKGROUND OF THE INVENTION

The benefits of my invention as I discovered and developed it are that I've found a way to secure a writing instrument to my shirt or coat more easily than can be done by using the conventional pen clip. I am also able to more easily secure my pen to my shirts or coats that do not have a pocket, using just one hand.

Based on a patent search performed by a Patent Attorney, of the most pertinent patents in the following classes and sub-classes: 224/901.8, 901.2, 24/3, 3.6, 3.12, 10, 12, 304 and 306 US and Foreign art. There is no existing patent exactly like the “holder for pens and the like,” regarding it's unique free turning, pivoting or rotating disk, combined with an attachment material or mechanism.

I believe the “holder for pens and the like” invention, is different than other pertinent art because of its pivoting or rotating disk and its practical and discrete means of attachment.

### BRIEF SUMMARY OF THE INVENTION

The object of the invention “holder for pens and the like” is to allow a person to more easily secure their favorite or preferred pen, pencil, other writing instrument or various other lightweight items, to their person or clothing. Compared to a conventional “pen clip” which can sometimes be difficult to attach to clothing without a pocket, or may require two hands to attach to clothing with a pocket. Or a “pen necklace,” or “recoiling pen on a string” which can be awkward to write with because of the distance between the user and the writing surface.

The “holder for pens and the like” does not require a pocket because it attaches to the clothing by other methods. The writing instrument easily attaches to the “holder for pens and the like” with one hand because it can be worn on the outer most piece of clothing in an open and accessible manner so that the wearer can place the writing instrument on to the “holder” by feeling for the disk with the forefinger and thumb while that forefinger and thumb are holding the writing instrument.

### BREIF DESCRIPTION OF THE SEVERAL VIEWS OF THE DRAWING

FIG. 1A Front view of “holder for pens and the like” clamping clip device, attached to the neck collar of an article of clothing, with writing instrument attached.

FIG. 1B Section view of writing instrument with attachment material applied.

FIG. 1C Section view of the “holder for pens and the like” clamping clip device, attached to the neck collar of an article of clothing.

FIG. 2A Front view of the “holder for pens and the like” clamping clip device, attached to the buttoned area of an article of clothing, with writing instrument attached.

FIG. 2B Section view of the “holder for pens and the like” clamping clip device, attached to buttoned area of an article of clothing.

FIG. 3A Front view of the “holder for pens and the like” clamping clip device, attached to pocket material of an article of clothing, with writing instrument attached.

FIG. 3B Section view of the “holder for pens and the like” clamping clip device, attached to pocket material of an article of clothing.

FIG. 4A Front view of the “holder for pens and the like” piercing pin device, attached to article of clothing, with writing instrument attached.

FIG. 4B Section view of the “holder for pens and the like” piercing pin device and backing clasp, as it would be attached to clothing material.

FIG. 5A Front view of the “holder for pens and the like” lanyard or neck strap device, with writing instrument attached, as it would be worn.

FIG. 5B Section view of the “holder for pens and the like” lanyard or neck strap device.

FIG. 6A Front view of the “holder for pens and the like” clamping clip device, attached to an automobile seatbelt strap.

FIG. 6B Front view of the “holder for pens and the like” clamping clip device, indicating that the disk will turn, pivot or rotate left to right or right to left.

FIG. 6C Section view of the “holder for pens and the like” clamping clip device, attached to an automobile seat belt strap.

FIG. 7A Front view of the “holder for pens and the like” clamping clip device, attached to an automobile seat belt strap, with a wireless phone attached.

FIG. 7B Section view of a typical wireless phone with attachment material applied.

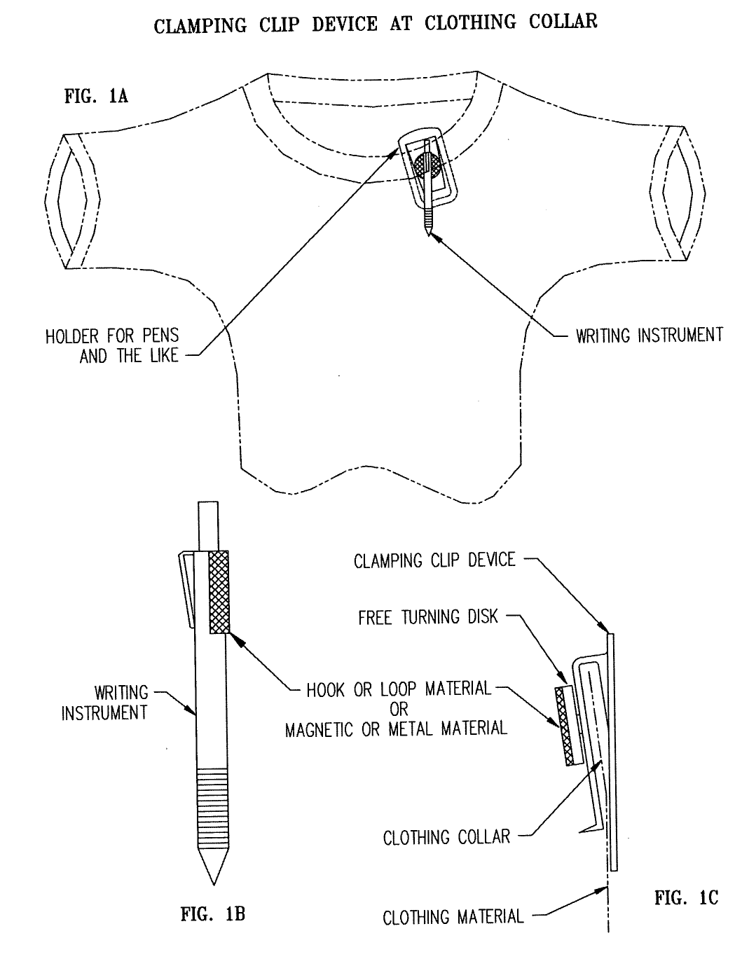

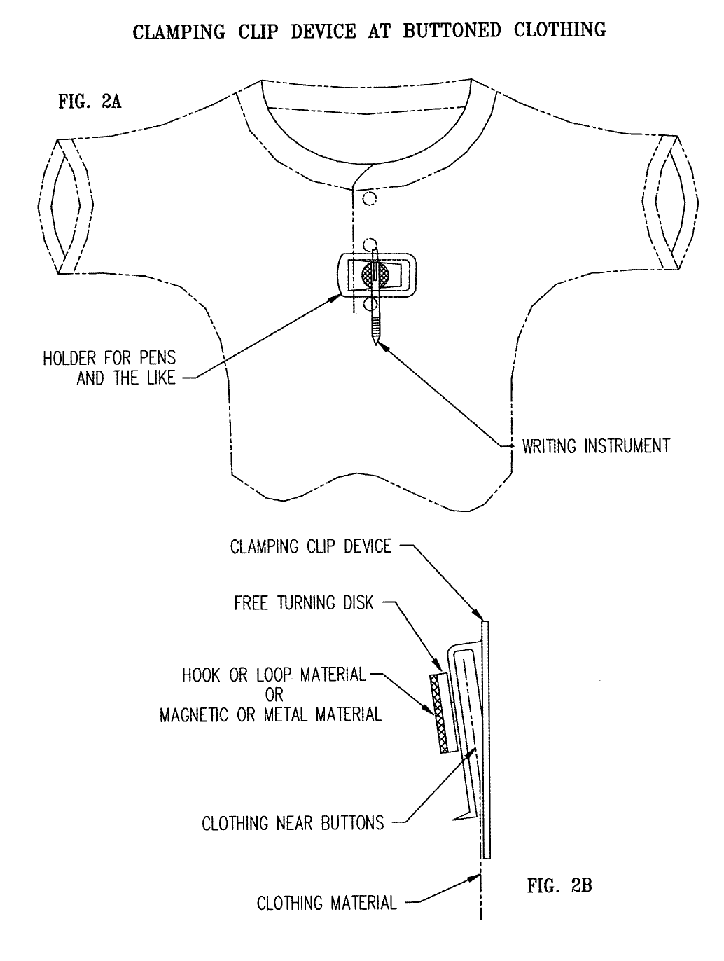

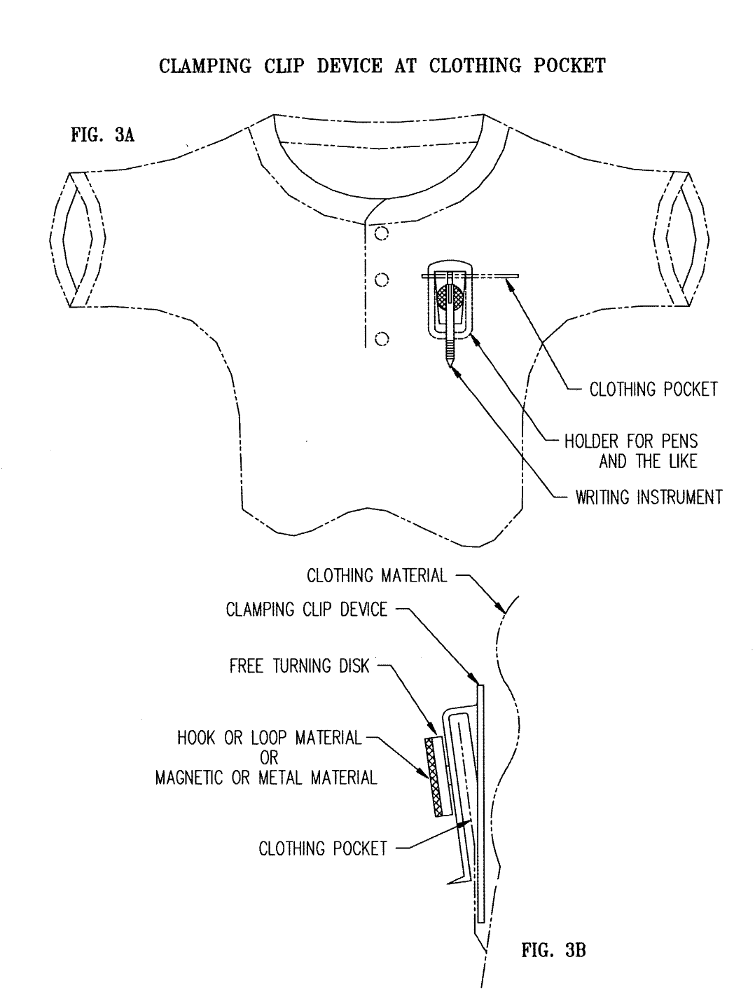

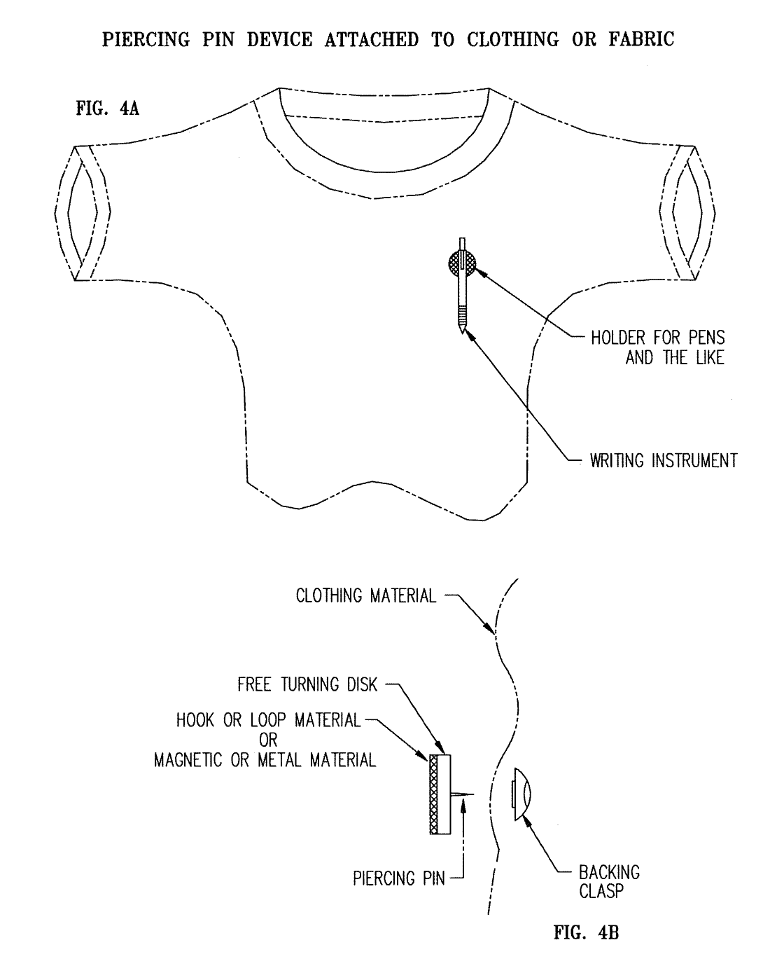

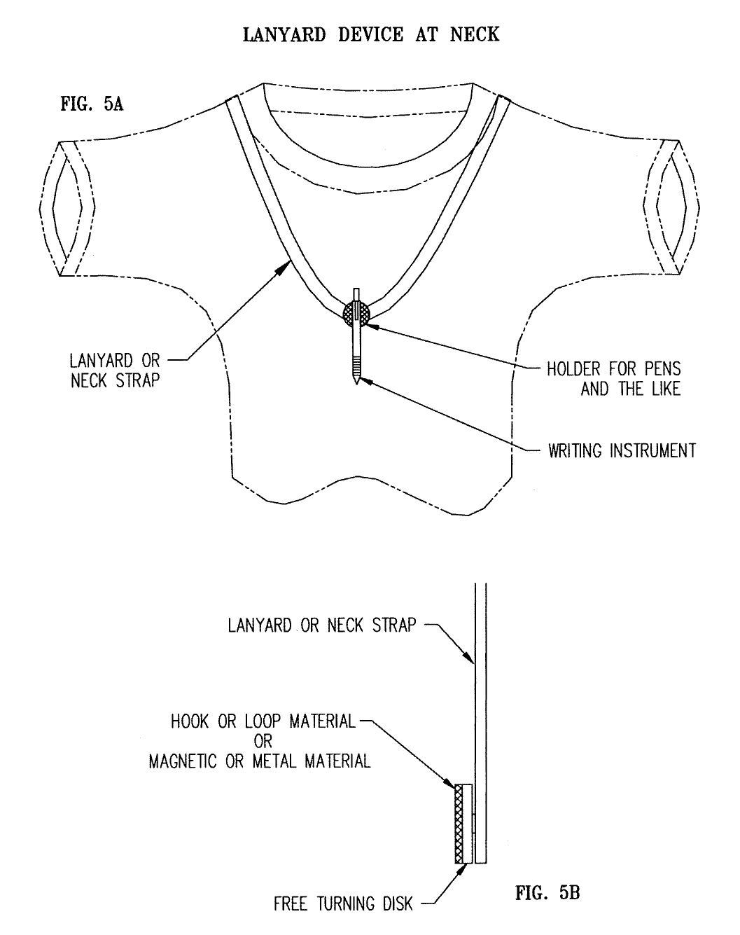

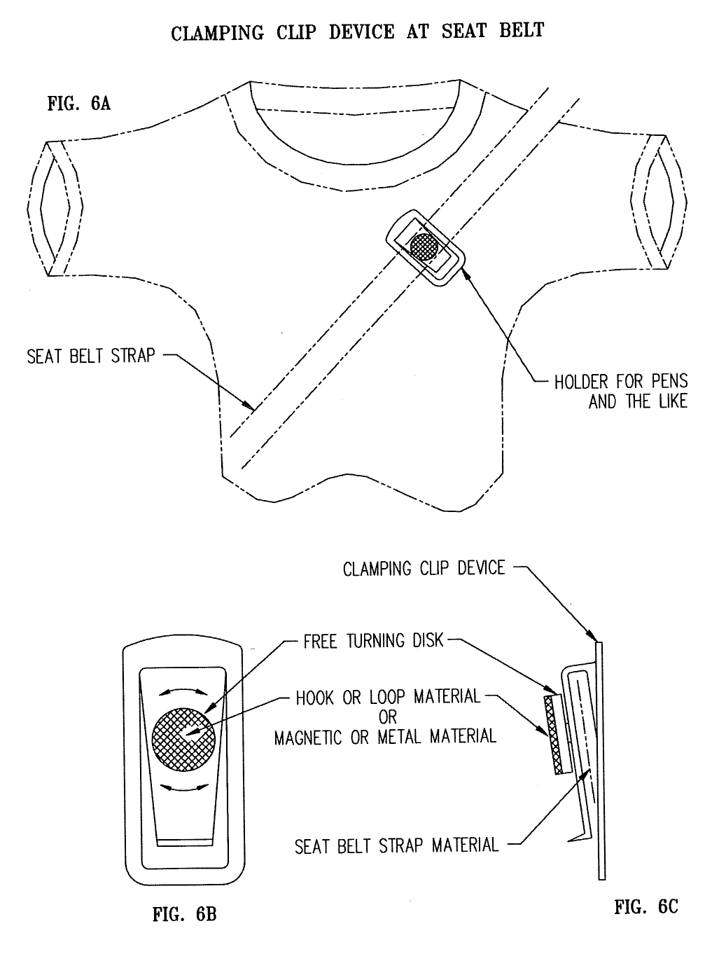

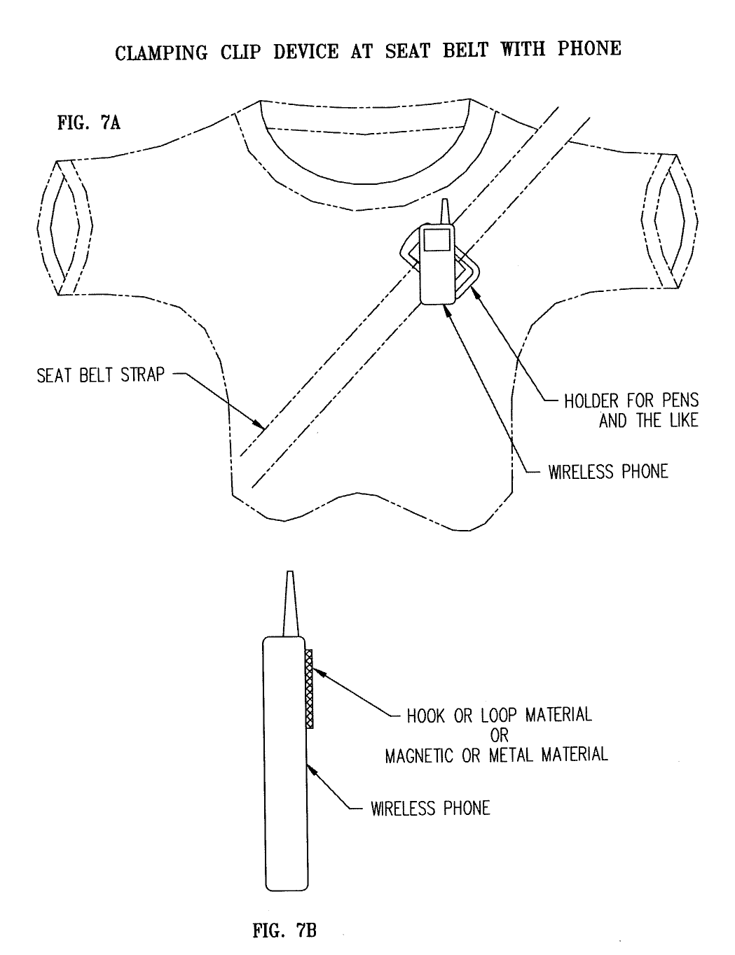

### DETAILED DESCRIPTION OF THE INVENTION

The “holder for pens and the like” utilizes a pivoting, rotating or free turning disk and various attachment materials. By securing the “holder for pens and the like” to a shirt, coat or automotive seatbelt strap in a convenient location, the user has a reliable and simple way to fasten and temporarily store their favorite writing instrument (or other lightweight items such as a cell phone to be used while driving an automobile), and have easy access to it. Use of the “holder for pens and the like,” completely eliminates the need for a pocket, or two hands some times required to clip your pen to your pocket or clothing. The writing instrument attaches simply, quickly and securely to the “holder for pens and the like” with just a touch, utilizing hook and loop material or magnetic material.

The “holder for pens and the like” can be used on any pocketless shirt or on the outside of a heavy winter work jacket. You can easily remove, and more importantly, you can more easily attach your writing instrument to the “holder for pens and the like” with just a touch of one hand.

The pivoting disk of the “holder for pens and the like” has attached to its surface, either a hook or loop material or a magnetic material or a metal material or other attachment materials or mechanisms.

The item to be attached to the “holder for pens and the like” would have attached to it, at a precise location, the opposite or other side of a hook and loop material or a magnetic material or a metal material. This will provide a sure means of attachment between the two items.

The “holder for Pens and the like” attaches to a person or persons clothing by several methods. The first and most original method of attachment is to have the rotating or pivoting disk of the “holder for pens and the like” manufactured on to a clamping clip, which clips to clothing, (or automobile seatbelt strap) in a variety of locations. This method, attaches to an article of clothing or other items quickly, yet still provides the pivoting action.

Another method of attachment is a direct attachment through the clothing fabric or other fabric material, with the use of a single post type “piercing pin” with a completely removable backing clasp, the same way an advertisement pin or an awards pin might attach to a persons shirt or coat. The single post type piercing pin pierces the clothing fabric and is secured with the backing clasp and is free to spin or rotate.

Another method of attachment is to secure the “holder for pens and the like” to a neck strap or lanyard that can be placed around a persons neck. The neck strap would also be manufactured with the rotating disk. The “holder for pens and the like” used with any of the attachment methods mentioned, still allows the disk to pivot or turn freely so that at whatever angle you secure your pen to the “holder for pens and the like”, gravity forces the pen to hang completely vertical every time.

The invention can be manufactured from various materials such as a lightweight cast metal or rigid vinyl or plastic.

The invention can be manufactured by the use of several existing manufacturing processes, including injection molded or extruded methods. The free turning or pivoting disk of “holder for pens and the like” can be manufactured in a variety of shapes (circular, octagon, square, or any shape in between). It can also be manufactured in various sizes (one inch or two inch diameters or larger or smaller).

What I claim as my invention “The holder for pens and the like.”

1. The free turning or pivoting disk of the “holder for pens and the like” is the distinctive feature, this feature will force any item that is attached to the pivoting disk, to hang vertically by virtue of gravity, when the attachment material is precisely placed on the attaching item.

2. Attaching the “holder for pens and the like” to your clothing never requires the use of a clothing pocket because it can be attached to a person or a persons clothing or other fabric material by several other methods, as is mentioned.

3. Attaching any item to the “holder for pens and the like” never requires the use of more than one hand because the “holder for pens and the like” can be worn on the outer most layer of clothing, or in an open or accessible area so that the wearer can place the item or writing instrument onto the “holder for pens and the like” by feeling for the disk, with the forefinger and thumb while holding the writing instrument.
